(19) United States
(12) Patent Application Publication
(10) Pub. No.: US 2025/0293469 A1
(43) Pub. Date: Sep. 18, 2025

(54) CONNECTOR MOUNTING STRUCTURE

(71) Applicant: TOYOTA JIDOSHA KABUSHIKI KAISHA, Toyota-shi (JP)

(72) Inventor: Tomoki SAKATA, Toyota-shi (JP)

(73) Assignee: TOYOTA JIDOSHA KABUSHIKI KAISHA, Toyota-shi (JP)

(21) Appl. No.: 18/971,539

(22) Filed: Dec. 6, 2024

(30) Foreign Application Priority Data
Mar. 15, 2024 (JP) 2024-040676

(51) Int. Cl. H01R 13/73; B60L 53/16; H01R 13/46

(52) U.S. Cl. CPC H01R 13/73; B60L 53/16; H01R 13/46; H01R 2201/26

(57) ABSTRACT

A connector mounting structure in which a connector is detachably attached to a case, in which the case has a connector fitting portion provided at an edge portion of an upper surface to be connected to an electrical device and with which the connector is fitted, the connector has a contact attached to the connector fitting portion, and a connector shell accommodating at least a part of the contact and the housing, and the connector shell is formed in a hook shape having an extending portion extending outward from above an edge portion of the upper surface of the case and a bent portion bending the outside of the case downward from the extending portion, and the wire extends downward from the lower end of the bent portion, and the contact protrudes from the lower surface of the extending portion and is fitted into the connector fitting portion from above.

### CROSS-REFERENCE TO RELATED APPLICATION

This application claims priority to Japanese Patent Application No. 2024-040676 filed on Mar. 15, 2024, incorporated herein by reference in its entirety.

### BACKGROUND

### 1. Technical Field

The present disclosure relates to a connector mounting structure.

### 2. Description of Related Art

As a connector mounting structure, there has conventionally been proposed a structure in which a connector is accommodated in a connector accommodating portion provided outside a case (main body portion) that accommodates an electric device (rotary electric machine) (see Japanese Unexamined Patent Application Publication No. 2009-38920 (JP 2009-38920 A), for example). In this structure, a connector cover having a flat plate shape is fixed to the connector accommodating portion. The connector cover includes a lid portion and an inclined portion. The lid portion covers an opening of the connector accommodating portion, and is fixed to the upper end surface of the connector accommodating portion by bolts. The inclined portion is inclined downward from the front end surface of the lid portion. The inclined portion can change the moving direction of another component when the component moves from the front due to a large impact from the front. As a result, deformation and breakage of the lid portion and the connector accommodating portion are suppressed to protect the connector.

### SUMMARY

In the above-described connector mounting structure, when the connector is used to connect the electrical device and the wire, there is a possibility that a defect such as deformation or breakage may occur in the wire due to an impact from the front. As a method of protecting the wire, it is conceivable to dispose the connector on the rear side of the case so that a load due to an impact from the front is received by the case. In this method, however, the case is located in front of the connector, and thus the case constitutes an obstacle when attaching and detaching the connector, reducing workability.

A main object of the connector mounting structure according to the present disclosure is to both protect a wire and suppress a reduction in workability in attaching and detaching a connector.

In order to achieve the above main object, the connector mounting structure according to the present disclosure adopts the following means.

An aspect of the present disclosure provides
a connector mounting structure in which a connector attached to a distal end of a wire and connecting an electrical device and the wire is detachably attached to a case accommodating the electrical device, in which:
the case includes
a connector fitting portion provided at an edge portion of an upper surface to be connected to the electrical device and with which the connector is fitted;
the connector includes
a contact attached to the connector fitting portion,
a housing in which the contact is incorporated, and
a connector shell accommodating at least a part of the contact and the housing,
the connector shell being formed in a hook shape having an extending portion extending outward from above the edge portion of the upper surface of the case with the connector attached to the case and a bent portion bent downward from the extending portion on an outer side of the case;
the wire extends downward from a lower end of the bent portion; and
the contact protrudes from a lower surface of the extending portion to be fitted with the connector fitting portion from above.

In the connector mounting structure according to the present disclosure, the case includes a connector fitting portion provided at an edge portion of an upper surface to be connected to an electrical device and with which the connector is fitted. The connector includes a contact attached to the connector fitting portion, a housing in which the contact is incorporated, and a connector shell accommodating at least a part of the contact and the housing. The connector shell is formed in a hook shape having an extending portion extending outward from above the edge portion of the upper surface of the case with the connector attached to the case and a bent portion bent downward from the extending portion on an outer side of the case. The wire extends downward from a lower end of the bent portion. Thus, a load on the bent portion from the direction opposite to the case can be received by the extending portion of the connector shell. Thus, it is possible to protect the wire. In addition, the contact protrudes from the lower surface of the extending portion to be fitted with the connector fitting portion from above. Thus, it is possible to suppress a reduction in workability in attaching and detaching the connector. As a result, it is possible to both protect the wire and suppress a reduction in workability in attaching and detaching the connector.

In the connector mounting structure according to the present disclosure,
the connector mounting structure may be mounted on a vehicle having an in-vehicle charger capable of charging an in-vehicle battery with electric power from outside;
the in-vehicle charger may be attached to the upper surface of the case; and
the connector may be disposed such that a rear end position of the connector in a front-rear direction of the vehicle substantially coincides with a rear end position of the in-vehicle charger.

With this configuration, a load from the rear of the vehicle is distributed between the connector and the in-vehicle charger, and thus the load applied to the connector can be reduced. Thus, the connector can be protected.

In the connector mounting structure according to the present disclosure, the connector may be disposed in a storage chamber partitioned by a partition plate from a rear occupant chamber.

With this configuration, the partition plate can be received by the connector shell, even if the partition plate is moved in the direction of the connector by a load from the rear side. Thus, the wire and the housing can be protected.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view illustrating an outline of an appearance of an in-vehicle device 10 mounted on a vehicle using a connector mounting structure according to an embodiment of the present disclosure as viewed from a side (a vehicle width direction (a left-right direction));

FIG. 2 is an explanatory diagram for explaining a state in which the in-vehicle device 10 is viewed from above;

FIG. 3 is a schematic perspective view of a connector mounting structure according to an embodiment;

FIG. 4 is an explanatory view for explaining the connector mounting structure of the embodiment; and

FIG. 5 is an explanatory diagram for explaining a direction of a load applied to the connectors 30 and 40, the in-vehicle charger 56, and the hydraulic device 58 when a load such as an impact is applied from the front of the vehicle.

### DETAILED DESCRIPTION OF EMBODIMENTS

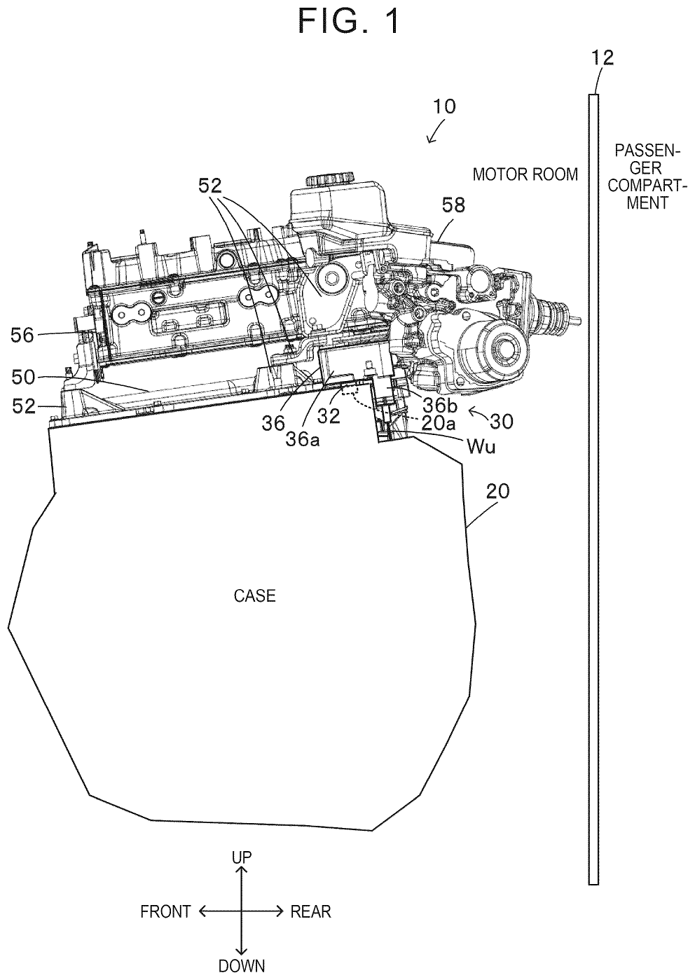

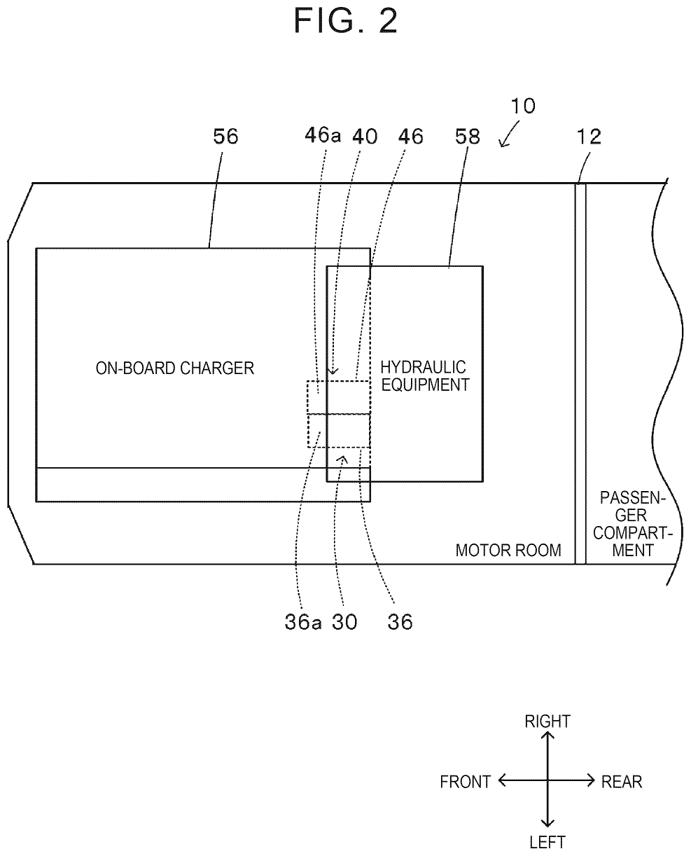

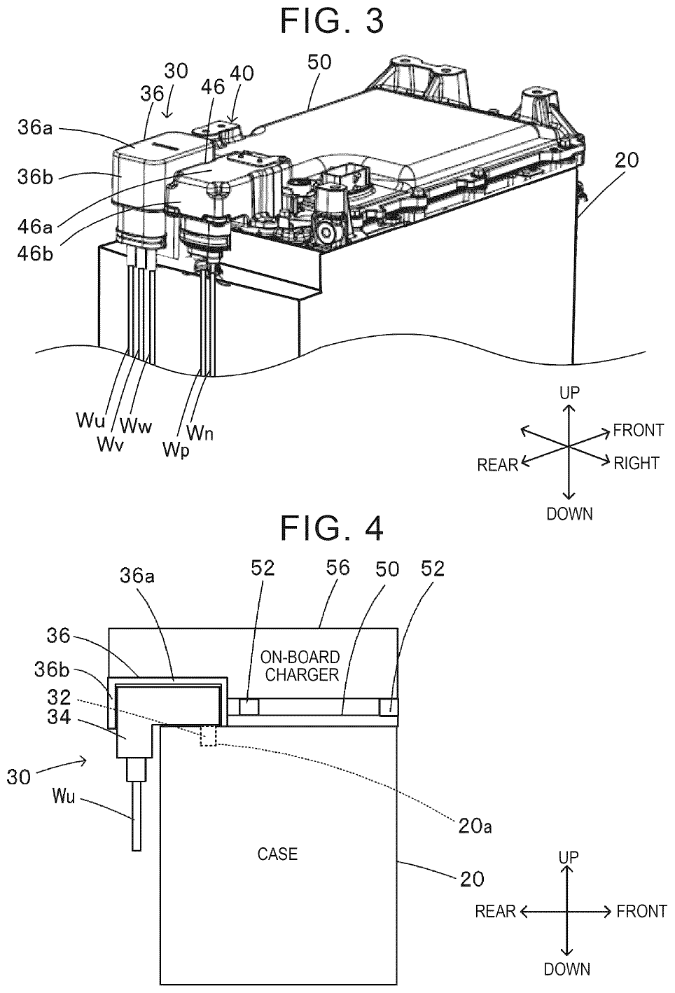

Embodiments of the present disclosure will be described with reference to the drawings. FIG. 1 is a schematic side view illustrating an outline of an appearance of an in-vehicle device 10 mounted on a vehicle using a connector mounting structure according to an embodiment of the present disclosure as viewed from a side (a vehicle width direction (a left-right direction)). FIG. 2 is an explanatory diagram for explaining a state in which the in-vehicle device 10 is viewed from above. FIG. 3 is a schematic perspective view illustrating a connector mounting structure of the embodiment. In FIG. 3, the in-vehicle charger 56 and the hydraulic device 58 are not shown for ease of explanation. FIG. 4 is an explanatory diagram for explaining a connector mounting structure of the embodiment. When the connector mounting structure of the embodiment is mounted on a vehicle, the height (up-down) direction, the front-rear direction, and the vehicle width (left-right) direction are as described in the drawings. Examples of vehicles in which the connector mounting structure of the embodiment is used include battery electric vehicle. Battery electric vehicle includes a motor for traveling, an inverter for driving the motor, a battery (in-vehicle battery) for exchanging electric power with the motor via the inverter, an in-vehicle charger 56 capable of charging the battery with electric power from the outside of the vehicle, and a hydraulic device 58 for supplying hydraulic pressure to a braking device for applying braking force to the vehicle.

As illustrated in FIGS. 1 to 4, the in-vehicle device 10 is fixed in a motor room (storage chamber) in a state in which a motor and an inverter (not illustrated) as an electric device are stored in the case 20. The motor room is separated from the passenger compartment by a dash panel (partition plate) 12 at a front portion of the vehicle. A connector fitting portion 20a and a connector fitting portion 20b (not shown) are provided at an edge portion of the upper surface of the case 20. The connector fitting portion 20a is connected to the U-phase to W-phase lines of the inverters while the connector 30 is detachably attached. The connector fitting portion 20b is connected to the power-line of the inverter with the connector 40 detachably attached. An upper cover 50 is attached to an upper surface of the case 20. The in-vehicle charger 56 is attached to the upper cover 50 by a plurality of brackets 52. A hydraulic device 58 is disposed behind the connectors 30 and 40 and the in-vehicle charger 56.

As illustrated in FIGS. 1 to 4, the connector 30 connects a wire Wu, Wv, Ww configured as a wire harness connected to the U-phase, V-phase, and W-phase coils of the motor in the case 20 and inverters in the case 20. The connector 30 includes a contact 32 attached to the connector fitting portion 20a, a housing 34 into which the contact 32 is incorporated, and a connector shell 36 that houses a portion of the contact 32 and the housing 34. The connector shell 36 is formed in a hook shape as a whole having an extending portion 36a extending outward from a rear-side edge portion of the upper surface of the case 20, and a bent portion 36b bending downward from the extending portion 36a toward the rear-side outer side of the case 20. The wire Wu, Wv, Ww extends downward from the lower end of the bent portion 36b. The contact 32 protrudes from the lower surface of the extending portion 36a and is fitted into the connector fitting portion 20a from above. Therefore, by moving the connector 30 downward from above the connector fitting portion 20a, the contact 32 can be fitted to the connector fitting portion 20a, and the connector 30 can be attached to the case 20. Also. By moving the connector 30 upward, the fitting of the contact 32 to the connector fitting portion 20a can be released, and the fitting of the connector 30 to the case 20 can be released. Accordingly, even in the motor room in which the front-rear direction is longer than the left-right direction, the connector is moved in the front-rear direction and detached. A decrease in the workability of attaching and detaching the connector 30 can be suppressed. The connector 30 is arranged such that the position of the rear end substantially coincides with the position of the rear end of the in-vehicle charger 56.

The connector 40 is connected to a wire Wp, Wn configured as a wire harness connected to a power line (positive electrode line, negative electrode line) from a battery. The connector 40, like the connector 30, is attached to a corresponding connector fitting portion 20b (not shown). The connector 40 includes a contact 42 (not shown), a housing 44 (not shown) into which the contact 42 is incorporated, and a connector shell 46 that houses a portion of the contact 42 and the housing 44. The connector shell 46 is formed in a hook shape as a whole having an extending portion 36a of the connector shell 36, an extension portion 46a having a configuration similar to that of the bent portion 36b, and a bent portion 46b. The wire Wp, Wn extends downward from the lower end of the bent portion 46b. Although not shown, the contact 42 protrudes from the lower surface of the extension portion 46a and is fitted into the connector fitting portion 20b of the case 20 from above. Therefore, by moving the connector 40 downward from above the connector fitting portion 20b, the contact 42 can be fitted to the connector fitting portion 20b, and the connector 40 can be attached to the case 20. Then, by moving the connector 40 upward, the fitting of the contact 42 to the connector fitting portion 20b can be released, and the attachment of the connector 40 to the case 20 can be released. Thus, even in the motor room in which the front-rear direction is relatively long, it is possible to suppress a decrease in the workability of attaching and detaching the connector 40. The connector 40 is arranged such that the position of the rear end substantially coincides with the position of the rear end of the in-vehicle charger 56.

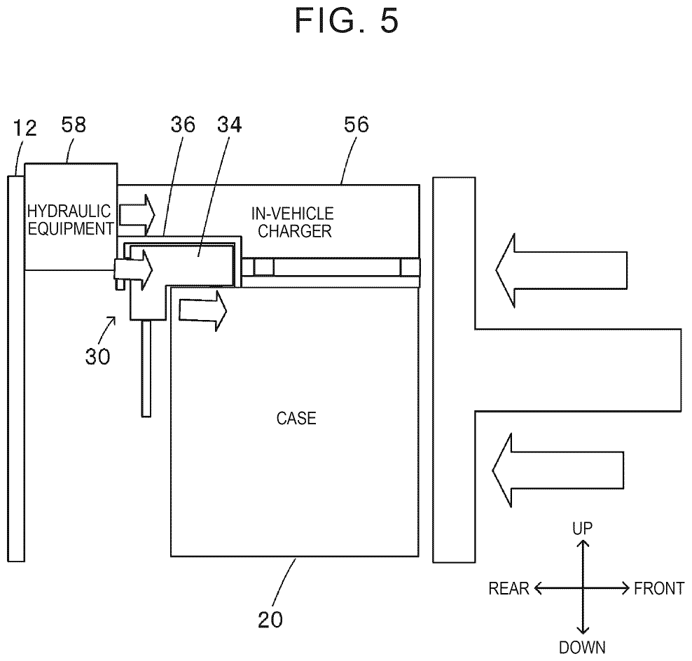

FIG. 5 is an explanatory diagram for explaining a direction of a load applied to the connectors 30 and 40, the in-vehicle charger 56, and the hydraulic device 58 when a load such as an impact is applied from the front of the vehicle. In FIG. 5, when a load is applied from the front of the vehicle indicating the direction of the load, a white arrow moves the entire case 20, the connectors 30 and 40, the in-vehicle charger 56, and the hydraulic device 58 backward, and the hydraulic device 58 hits the dash panel 12. When the hydraulic device 58 hits the dash panel 12, a forward load is applied to the hydraulic device 58 by a reaction force from the dash panel 12. In the embodiment, the rear end positions of the connectors 30 and 40 substantially coincide with the rear end positions of the in-vehicle charger 56. Therefore, since the forward load from the hydraulic device 58 is distributed between the connectors 30 and 40 and the in-vehicle charger 56, the load applied to the connectors 30 and 40 can be reduced. Thus, the connectors 30 and 40 can be protected. At this time, since the connectors 30 and 40 receive a load from the rear at the bent portion 46b of the connector shells 36 and 46, the wire Wu, Wv, Ww, Wp, Wn and the housings 34 and 44 can be protected.

According to the connector mounting structure of the present embodiment described above, the connector 30 includes the contacts 32 and 42 attached to the connector fitting portion 20a, 20b, the housings 34 and 44 in which the contacts 32 and 42 are incorporated, and the connector shells 36 and 46 that accommodate a part of the contacts 32 and 42 and the housings 34 and 44. The connector shells 36 and 46 have an extending portion 36a, 36a extending outward from a rearward edge portion of the upper surface of the case 20, and a bent portion 36b, 46b bending downward from the extending portion 36a, 46a toward a rearward outer side of the case 20. The connector shells 36, 46 are formed as a whole in a hook shape. The wire Wu, Wv, Ww, Wp, Wn extends downward from the lower end of the bent portion 36b, 46b. The contacts 32 and 42 protrude from the lower surface of the extending portion 36a, 46a and fit into the connector fitting portion 20a from above. According to the above-described configuration, it is possible to achieve both the protection of the wire Wu, Wv, Ww, Wp, Wn and the suppression of the decrease in the workability of attaching and detaching the connectors 30 and 40.

In addition, the connector mounting structure of the present embodiment is mounted on a vehicle having an in-vehicle charger 56 capable of charging an in-vehicle battery with electric power from the outside. The in-vehicle charger 56 is attached to the upper surface of the case 20, and the connectors 30 and 40 are arranged such that the rear end position of the vehicle in the front-rear direction substantially coincides with the rear end position of the in-vehicle charger 56. With this structure, the connectors 30 and 40 can be protected.

Further, the connectors 30, 40 can protect the wire Wu, Wv, Ww, Wp, Wn and the housings 34, 44 from being located in the motor room separated by the dash panel 12 from the rear passenger compartment.

In the above-described embodiment, the hydraulic device 58 is disposed behind the connectors 30 and 40 and the in-vehicle charger 56. However, the hydraulic device 58 may not be disposed behind the connectors 30 and 40 and the in-vehicle charger 56. Here, the rear surface of the bent portion 36b, 46b of the connectors 30 and 40 may be attached to the dash panel 12.

In the above-described embodiment, the in-vehicle charger 56 is attached to the upper cover 50. However, the in-vehicle charger 56 may not be attached to the upper cover 50.

In the above-described embodiment, the connector mounting structure of the embodiment of the present disclosure is applied to a vehicle. However, the connector mounting structure of the embodiment of the present disclosure is not limited to the one applied to the vehicle. The present disclosure may be applied to any connector mounting structure in which a connector attached to a leading end of a wiring and connecting the electrical device and the wiring is detachably attached to a case accommodating the electrical device.

The correspondence between the main elements of the embodiments and the main elements of the disclosure described in the column of the means for solving the problem will be described. In the embodiment, the case 20 corresponds to the “case”, the connector 30 corresponds to the “connector”, the contact 32 corresponds to the “contact”, the housing 34 corresponds to the “housing”, the extending portion 36a corresponds to the “extension portion”, the bent portion 36b corresponds to the “bent portion”, the connector shell 36 corresponds to the “connector shell”, the wire Wu corresponds to the “wiring”, and the connector fitting portion 20a corresponds to the “connector fitting portion”.

The correspondence between the main elements of the embodiment and the main elements of the disclosure described in the section of the means for solving the problem is an example for specifically explaining the embodiment of the disclosure described in the section of the means for solving the problem. Therefore, the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to a manufacturing industry of an apparatus in which a connector mounting structure is mounted.

What is claimed is:

1. A connector mounting structure in which a connector attached to a distal end of a wire and connecting an electrical device and the wire is detachably attached to a case accommodating the electrical device, wherein:
the case includes
a connector fitting portion provided at an edge portion of an upper surface to be connected to the electrical device and with which the connector is fitted;
the connector includes
a contact attached to the connector fitting portion,
a housing in which the contact is incorporated, and
a connector shell formed in a hook shape having an extending portion extending outward from the edge portion of the upper surface of the case and a bent portion bent downward from the extending portion on an outer side of the case, the connector shell accommodating at least a part of the contact and the housing;
the wire extends downward from a lower end of the bent portion; and
the contact protrudes from a lower surface of the extending portion to be fitted with the connector fitting portion from above.

2. The connector mounting structure according to claim 1, wherein:
the connector mounting structure is mounted on a vehicle having an in-vehicle charger capable of charging an in-vehicle battery with electric power from outside;
the in-vehicle charger is attached to the upper surface of the case; and
the connector is disposed such that a rear end position of the connector in a front-rear direction of the vehicle substantially coincides with a rear end position of the in-vehicle charger.

3. The connector mounting structure according to claim 1, wherein the connector is disposed in a storage chamber partitioned by a partition plate from a rear occupant chamber.
